(19) United States
(12) Patent Application Publication
(10) Pub. No.: US 2008/0163707 A1
(43) Pub. Date: Jul. 10, 2008

(54) Angle adjustable gauge assembly

(76) Inventor: Tsung Min Wu, Tainan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/651,044

(22) Filed: Jan. 9, 2007

(51) Int. Cl. G01D 7/02

(52) U.S. Cl. 73/866.3

(57) ABSTRACT

An angle adjustable gauge assembly includes a gauge having a casing and a gauge body received in the casing. A clamping member is secured to the casing to move therewith. The clamping member includes a hole receiving a rod of a vehicle. A lining member is mounted between the clamping member and the rod. The lining member includes an inner periphery securely engaged with the rod. The lining member further includes an outer periphery in frictional contact with an inner periphery defining the hole of the clamping member to thereby retain the clamping member to the outer periphery of the lining member. The clamping member and the gauge are moved relative to the lining member when a force sufficient to overcome the frictional force between the inner periphery defining the hole of the clamping member and the outer periphery of the lining member is applied to the clamping member.

### BACKGROUND OF THE INVENTION

1. Field of the Invention

The present invention relates to a gauge assembly and, more particularly, to an angle adjustable gauge assembly of a vehicle.

2. Description of the Related Art

A vehicle generally includes a plurality of gauges including a tachometer, a speedometer, an odometer, a gas gauge, etc. to provide the driver with information of conditions of the vehicle. A typical gauge comprises electronic mechanisms (such as electric circuits and electronic components for processing, operation, and driving purposes) housed in a casing. To suit outlines of motorcycles of various types and to meet requirements of visual angles of the driver, the gauge is clamped to a rod (such as a handlebar or a balancing rod) of a vehicle by a clamping device. The gauge is tightly clamped to the rod such that the driver's eyes must follow the position of the gauge, leading to inconvenience in some cases.

### SUMMARY OF THE INVENTION

An angle adjustable gauge assembly in accordance with the present invention includes a gauge having a casing and a gauge body received in the casing. A clamping member is secured to the casing to move therewith. The clamping member includes a hole receiving a rod of a vehicle. A lining member is mounted between the clamping member and the rod. The lining member includes an inner periphery securely engaged with the rod. The lining member further includes an outer periphery in frictional contact with an inner periphery defining the hole of the clamping member to thereby retain the clamping member to the outer periphery of the lining member.

The clamping member and the gauge are moved relative to the lining member when a force sufficient to overcome the frictional force between the inner periphery defining the hole of the clamping member and the outer periphery of the lining member is applied to the clamping member. When the force is released, the clamping member and the gauge are retained in place by the frictional force between the inner periphery defining the hole of the clamping member and the outer periphery of the lining member.

In a preferred form, the clamping member includes a first part and a second part. The first and second parts, when assembled, together form the hole receiving the rod.

In the preferred form, the lining member includes first and second arcuate sections. Each of the first and second arcuate sections includes an inner periphery securely engaged with the rod and an outer periphery in frictional contact with the inner periphery defining the hole of the clamping member to thereby retain the clamping member to the outer periphery of the lining member.

The angle adjustable gauge assembly in accordance with the present invention provides the driver with good vision as well as excellent maneuverability. Furthermore, the angle adjustable gauge assembly in accordance with the present invention can be assembled and dismantled easily.

Other objectives, advantages, and novel features of the invention will become more apparent from the following detailed description when taken in conjunction with the accompanying drawings.

### BRIEF DESCRIPTION OF THE DRAWINGS

FIG. 1 is a perspective view of an angle adjustable gauge assembly in accordance with the present invention.

FIG. 2 is an exploded perspective view of the angle adjustable gauge assembly in accordance with the present invention.

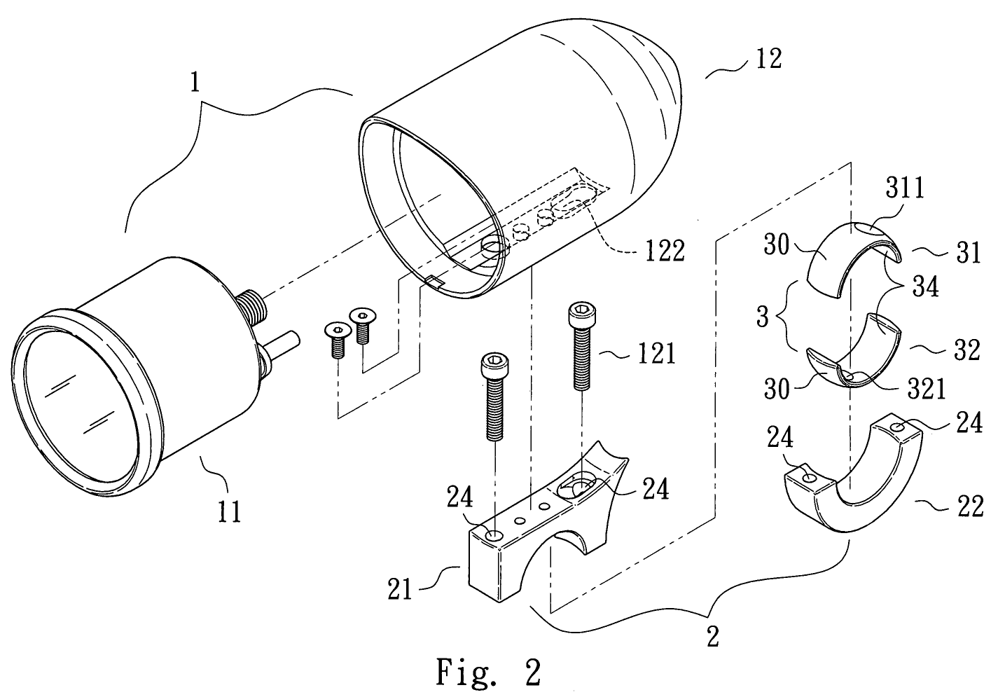

FIG. 3 is a perspective view illustrating mounting of the angle adjusting gauge assembly in accordance with the present invention on a handlebar of a vehicle.

FIG. 4 is a view similar to FIG. 3, illustrating adjustment of the angle adjusting gauge-assembly in a direction.

FIG. 5 is a view similar to FIG. 3, illustrating adjustment of the angle adjusting gauge assembly in another direction.

### DETAILED DESCRIPTION OF THE PREFERRED EMBODIMENT

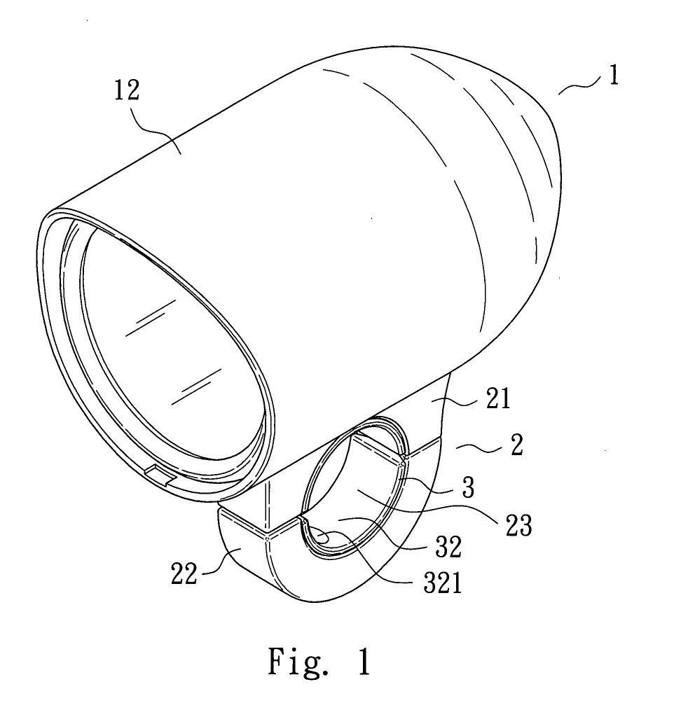

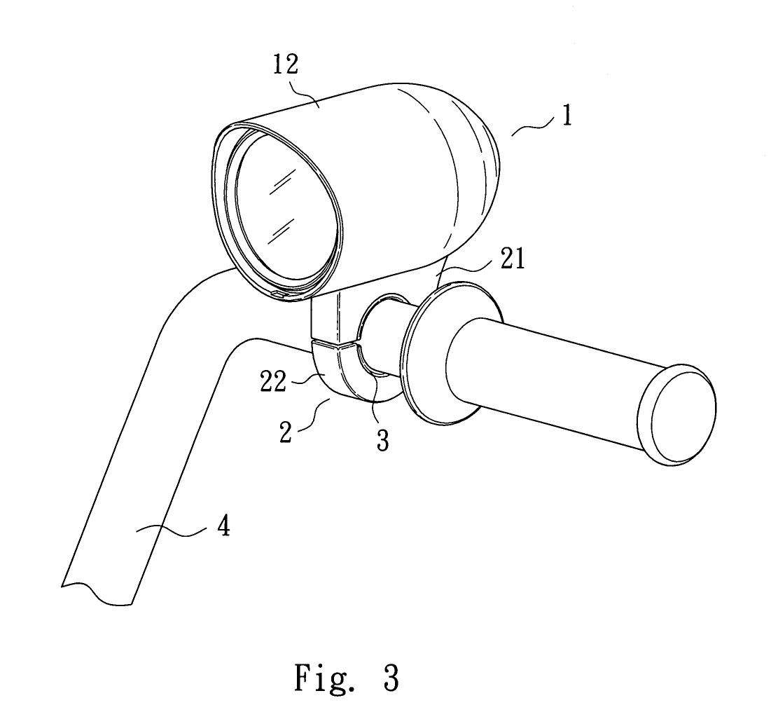

Referring to FIGS. 1 and 3, an angle adjustable gauge assembly in accordance with the present invention comprises a gauge 1, a clamping member 2, and a lining member 3. The gauge 1 includes a gauge body 11 and a casing 12 in which the gauge body 11 is received. The gauge body 11 includes a plurality of elements (not shown) mounted therein and a panel (not shown) for displaying purposes. Detailed structure of the gauge body 11 is not the subject matter of the present invention and, thus, not described in detail.

The clamping member 2 is fixed to the casing 12. In this example, screws 121 are extended through holes 122 in the casing 12 and holes (not labeled) in the clamping member 2. The clamping member 2 includes a first part 21 and a second part 22. The first and second parts 21 and 22 together define a hole 23 for receiving a rod 4 of a vehicle. The first and second parts 21 and 22 can be mounted to the rod 4 at any desired angular position by extending the screws 121 through holes 24 in the first and second parts 21 and 22.

The lining member 3 is mounted in the hole 23 of the clamping member 2 and has an outer periphery 30 in contact with an inner periphery defining the hole 23. The outer periphery 30 of the lining member 3 is in frictional contact with the inner periphery defining the hole 23 of the clamping member 2. Furthermore, the lining member 3 has an inner periphery 34 securely engaged with the rod 4 of the vehicle. Namely, the lining member 3 will not rotate relative to the rod 4. In this example, the lining member 3 includes a first arcuate section 31 and a second arcuate section 32. Each of the first and second arcuate sections 31 and 32 has a wire hole 311, 321 through which wires of the gauge 1 extends. Each of the first and second arcuate sections 31 and 32 has an outer periphery 30 frictional contact with the inner periphery defining the hole 23 of the clamping member 2. Each the first and second arcuate sections 31 and 32 has an inner periphery 34 securely engaged with the rod 4.

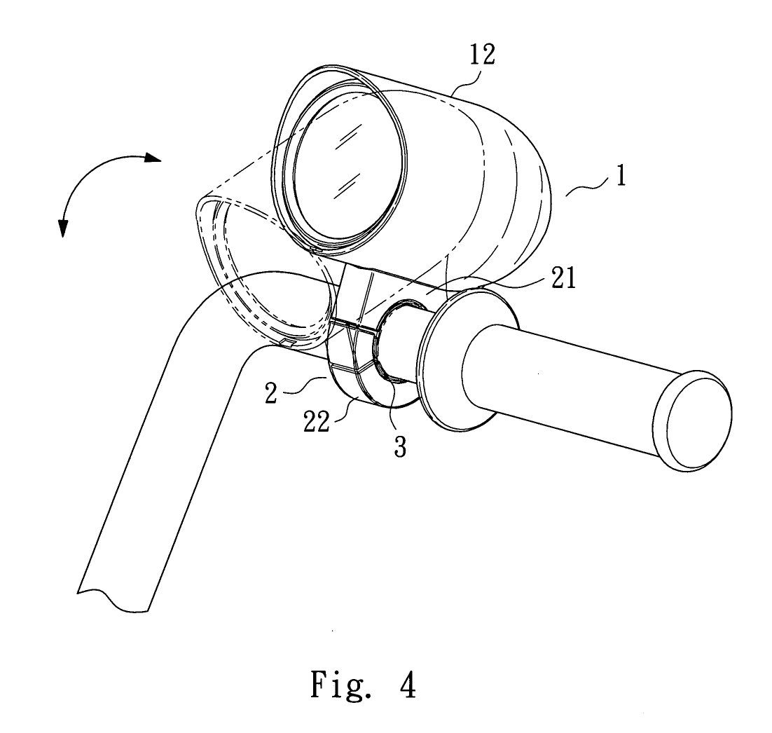

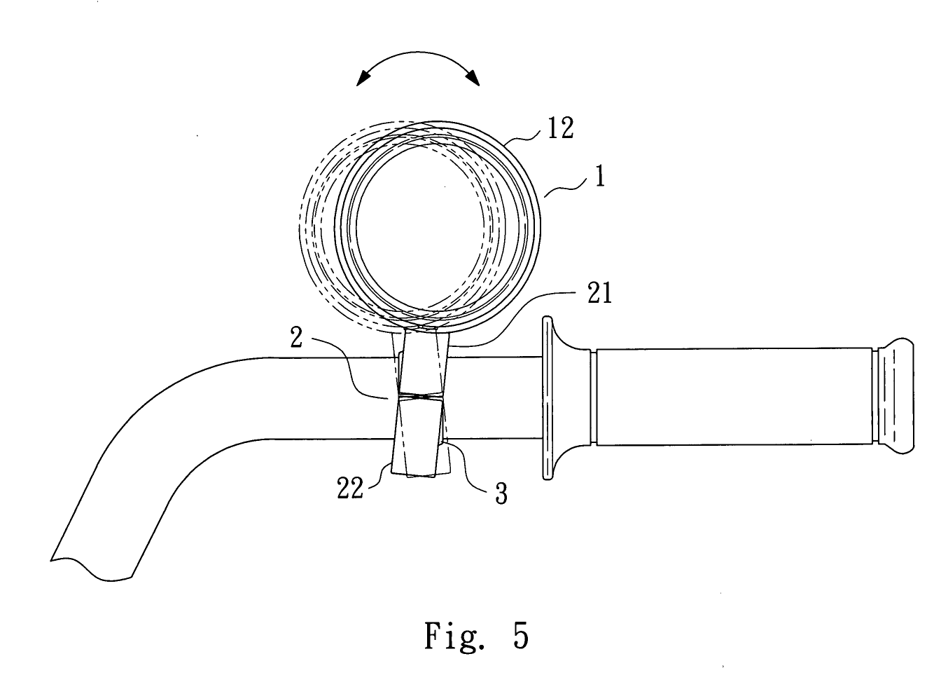

The gauge 1 is mounted to the rod 4 of the vehicle, with the lining member 3 being fixed between the clamping member 2 and the rod 4 and not rotatable relative to the rod 4, and with the clamping member 2 being frictionally retained to the outer peripheries 30 of the first and second arcuate sections 31 and 32 of the lining member 3. Namely, the clamping member 2 and the gauge 1 are retained in place by the friction between the inner periphery defining the hole 23 of the clamping member 2 and the outer peripheries of the first and second arcuate sections 31 and 32 of the lining member 3. Nevertheless, the clamping member 2 and the gauge 1 can be pivoted to a desired angular position relative to the lining member 3 and the rod 4 of the vehicle by applying a rotational force to the clamping member 2 to overcome the frictional force. When the rotational force is released, the clamping member 2 and the gauge 1 are retained in place again. With reference to FIG. 4, the clamping member 2 can be turned forward or rearward relative to the lining member 3 about an axis of the rod 4 as long as a rotational force overcoming the frictional force is applied. Also, the clamping member 2 can be slightly pivoted leftward or rightward relative to the rod 4 (i.e., in a lengthwise direction of the rod), as shown in FIG. 5. Hence, the gauge 1 can be adjusted to be in any desired angular position relative to the driver.

Although a specific embodiment has been illustrated and described, numerous modifications and variations are still possible without departing from the essence of the invention. The scope of the invention is limited by the accompanying claims.

What is claimed is:

1. An angle adjustable gauge assembly comprising, in combination:
a gauge including a casing and a gauge body received in the casing;
a clamping member secured to the casing to move therewith, the clamping member including a hole receiving a rod of a vehicle; and
a lining member mounted between the clamping member and the rod, the lining member including an inner periphery securely engaged with the rod, the lining member further including an outer periphery in frictional contact with an inner periphery defining the hole of the clamping member to thereby retain the clamping member to the outer periphery of the lining member;
wherein the clamping member and the gauge are moved relative to the lining member when a force sufficient to overcome the frictional force between the inner periphery defining the hole of the clamping member and the outer periphery of the lining member is applied to the clamping member; and
wherein the clamping member and the gauge are retained in place by the frictional force between the inner periphery defining the hole of the clamping member and the outer periphery of the lining member when the force is released.

2. The angle adjustable gauge assembly as claimed in claim 1 wherein the clamping member includes a first part and a second part, and wherein the first and second parts together form the hole when assembled.

3. The angle adjustable gauge assembly as claimed in claim 1 wherein the lining member includes first and second arcuate sections, each of the first and second arcuate sections including an inner periphery securely engaged with the rod and an outer periphery in frictional contact with the inner periphery defining the hole of the clamping member to thereby retain the clamping member to the outer periphery of the lining member.
